(19) United States
(12) Patent Application Publication
(10) Pub. No.: US 2013/0135218 A1
(43) Pub. Date: May 30, 2013

(54) TACTILE AND GESTATIONAL IDENTIFICATION AND LINKING TO MEDIA CONSUMPTION

(71) Applicants: Anand Jain, Ellicott City, MD (US); John Stavropoulos, Edison, NJ (US); Alan Neuhauser, Silver Spring, MD (US); Wendell Lynch, East Lansing, MI (US); Vladimir Kuznetsov, Ellicott City, MD (US); Jack Crystal, Owings Mills, MD (US)

(72) Inventors: Anand Jain, Ellicott City, MD (US); John Stavropoulos, Edison, NJ (US); Alan Neuhauser, Silver Spring, MD (US); Wendell Lynch, East Lansing, MI (US); Vladimir Kuznetsov, Ellicott City, MD (US); Jack Crystal, Owings Mills, MD (US)

(73) Assignee: ARBITRON INC., COLUMBIA, MD (US)

(21) Appl. No.: 13/307,599

(22) Filed: Nov. 30, 2011

(51) Int. Cl. G06F 3/041

(52) U.S. Cl. 345/173

(57) ABSTRACT

Systems and methods are disclosed for identifying users of touch screens according to a touch/gesture profile. The profile includes stored electrical characteristics of contact with the touch screen. The profile is correlated with applications opened and/or accessed, along with any associated metadata, as well as media exposure data derived from audio received at the device. The correlated information may be used to confirm identification of one or more individuals using a device for audience measurement purposes.

### TECHNICAL FIELD

The present disclosure is directed to processor-based audience analytics. More specifically, the disclosure describes systems and methods for processing electronic signals from touch screen sensors to create user profiles, and further linking the profiles to media consumption through application usage and/or exposure to media.

### BACKGROUND INFORMATION

The recent surge in popularity of touch screen phones and tablet-based computer processing devices, such as the iPad™, Xoom™, Galaxy Tab™ and Playbook™ has spurred new dimensions of personal computing. The touch screen enables persons to interact directly with what is displayed, rather than indirectly with a pointer controlled by a mouse or touchpad. Furthermore, touch screens allow people to interact with the computer without requiring any intermediate device that would need to be held in the hand. The touch screen displays can be attached to computers, or to networks as terminals and play a prominent role in the design of digital appliances such as the personal digital assistant (PDA), satellite navigation devices, mobile phones, and video games.

In addition to personal computing, the portability of touch screen devices makes them good candidates for audience measurement purposes. In addition to measuring on-line media usage, such as web pages, programs and files, touch screen devices are particularly suited for surveys and questionnaires. Furthermore, by utilizing specialized microphones, touch screen devices may be used for monitoring user exposure to media data, such as radio and television broadcasts, streaming audio and/or video, billboards, products, and so one. Some examples of such applications are described in U.S. patent application Ser. No. 12/246,225, titled “Gathering Research Data” to Joan Fitzgerald et al., U.S. patent application Ser. No. 11/643,128, titled “Methods and Systems for Conducting Research Operations” to Gopalakrishnan et al., and U.S. patent application Ser. No. 11/643,360, titled “Methods and Systems for Conducting Research Operations” to Flanagan, III et al., each of which are assigned to the assignee of the present application and are incorporated by reference in their entirety herein.

One area of touch-screen audience measurement requiring improvement is the area of user identification. Conventional identification configurations include the use of peripherals, such as fingerprint readers, iris scanners, that are expensive and impractical to use. Other configurations include the use of log-in scripts and the like, which are viewed with disfavor by users. Furthermore, such configurations are not particularly effective at detecting circumstances where a user logs in or registers with a device, and then passes off the device to another user. While the device will continue to monitor data usage and/or media exposure, the monitoring software will attribute the usage and exposure to the wrong person.

What are needed are systems and methods that allow a touch screen device to be able to recognize one or more users according to a “touch profile” that uniquely identifies each user. Additionally, the touch profile may be used to determine if a non-registered person is using the device at a particular time. Such configurations are advantageous in that they provide a non-intrusive means for identifying users according to the way they use a touch screen device, instead of relying on data inputs provided by a user at the beginning of a media session, which may or may not correlate to the user actually using the device.

### SUMMARY

Under certain embodiments, computer-implemented methods and systems are disclosed for processing data in a tangible medium for registering touch-screen inputs and/or confirming the identity of one or more users of a touch screen device. Systems and processes are disclosed for receiving contact data from touch screen circuitry relating to a contact made with the touch screen device by a user and receiving (i) application data relating to one or more applications accessed in the touch screen device, and/or (ii) media exposure data relating to audio received in the touch screen device. The contact data is then correlated with the application data and media exposure data, and the contact data is compared with stored contact data to determine if a match exists. Other embodiments disclosed and claimed herein will be apparent to those skilled in the art.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary configuration for registering touches on a touch screen;

FIGS. 2A and 2B illustrate an exemplary registration of a touch on a capacitive touch screen;

FIG. 3 illustrates an exemplary hardware configuration for a touch screen;

FIG. 4 is an exemplary touch screen processing device configured to register touch profiles, data usage and/or media exposure under an exemplary embodiment;

FIG. 5 illustrates exemplary gestational actions capable of being registered as part of a touch profile;

FIGS. 6A and 6B illustrate exemplary touch parameters and touch orientation capable of being registered as part of a touch profile;

FIGS. 7A and 7B illustrate an exemplary gesture parameter capable of being registered as part of a touch profile;

FIG. 8 illustrates an exemplary process for processing touch characteristics for identifying users for monitoring data usage and/or media exposure; and

FIG. 9 illustrates another embodiment illustrating the registration and recognition of panelists utilizing user touch screen profiles and associating them with a media session.

### DETAILED DESCRIPTION

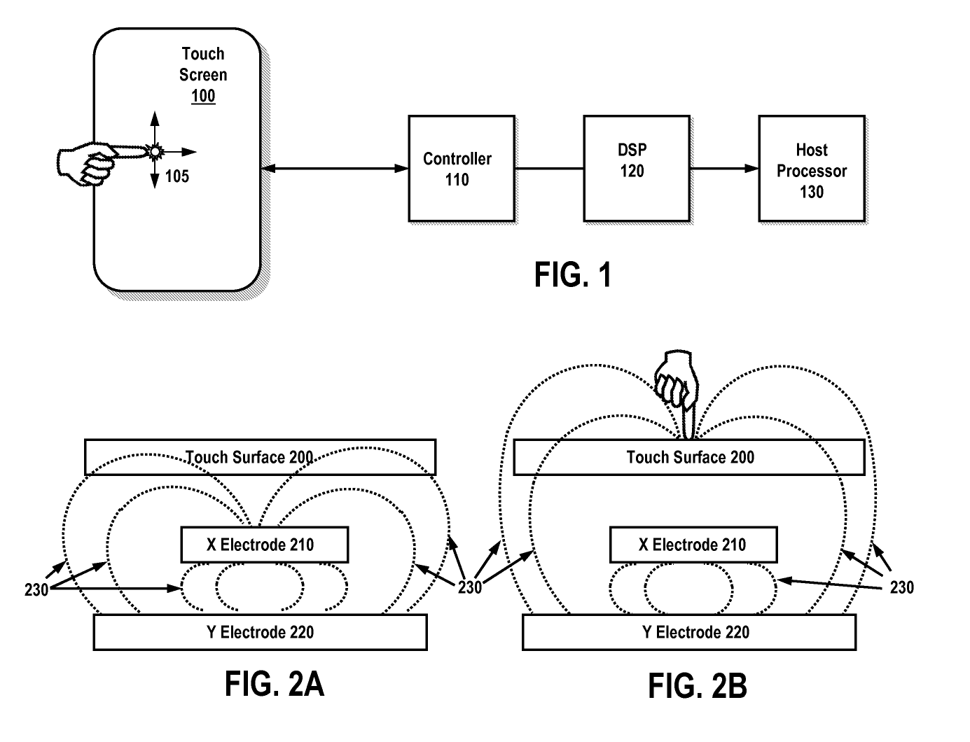

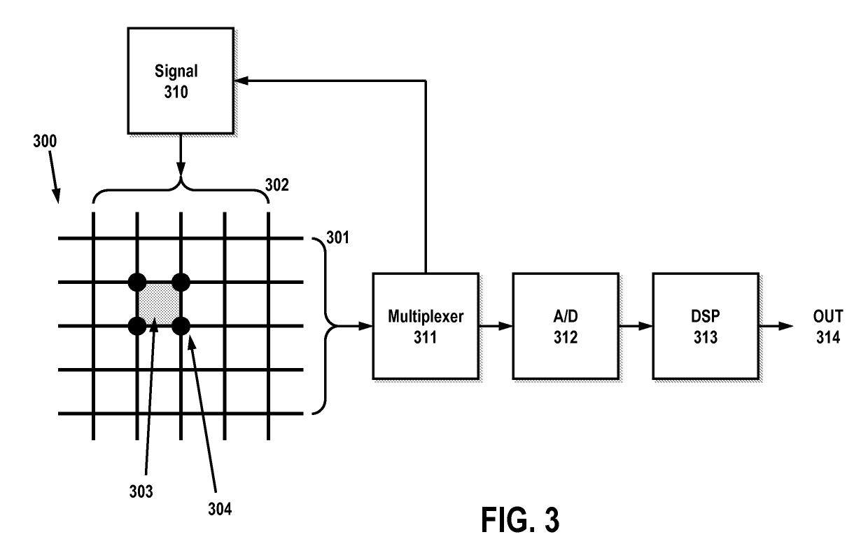

FIG. 1 illustrates a configuration for registering one or more areas of contact 105 (also known as “multi-touch”) on touch screen 100 having an integrated touch screen sensor. For the purposes of simplicity, the disclosure pertaining to FIGS. 1-3 will refer to a capacitive touch screen configuration. However, it is understood by those skilled in the art that the principles described below are equally applicable to other touch screen configurations, such as resistive touch screens, infrared, optical, and Surface Acoustic Wave (SAW) technology. As can be seen from FIG. 1, touch screen 100 is configured to detect contact with the touch screen surface that is operatively coupled to sensor on the touch screen (see FIG. 3). Under one embodiment, touch screen panel 100 includes an insulator such as glass, coated with a transparent conductor such as Indium Tin Oxide (ITO). As is shown in FIGS. 2A-B touching the surface of the screen by a human finger (which is also an electrical conductor) results in a distortion of the screen's electrostatic field, measurable as a change in capacitance. Accordingly, a small amount of charge is drawn to the point of contact. Circuitry located at each corner of the panel (not shown) measures the charge and location, and sends the information to controller 110 for processing.

Under a surface capacitance configuration, only one side of the insulator is coated with a conductive layer, and a small voltage is applied to the layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. Under a Projected Capacitice Touch (PCT) configuration, An X-Y grid is formed either by etching a single layer to form a grid pattern of electrodes, or by etching two separate, perpendicular layers of conductive material with parallel lines or tracks to form the grid. A finger on a grid of conductive traces changes the capacitance of the nearest traces, wherein the change in capacitance is measured and used to determine finger position. In a simplified form, the capacitance may be expressed as

$$C = \frac{ɛ A}{d}$$

where ∈ is the dielectric constant, A is the area and d is the distance. Accordingly, the larger the trace area (A) exposed to a finger, the larger the signal. Also, the smaller the distance d between the finger and the sensor, the larger the signal will be. Thus, the size of the signal (or change of capacitance on the sensor) due to finger contact will be proportional to the overlapping area between the finger and the sensor.

Turning briefly to FIG. 2A, an exemplary illustration is provided where touch surface 200 is configured above X electrode 210 and Y electrode 220. The electrical field 230 is illustrated using the dotted lines. As a finger comes in contact with touch surface 200 in FIG. 2B, the finger attracts charge away from X electrode 210, which in turn alters the capacitance between the X and Y electrodes. The electrical field 230 then “projects” beyond the touch surface.

Generally speaking, since capacitive touch screen sensors provide a ratio between voltage and charge, capacitance may be measured by (a) applying known voltages on the sensor and measuring the resulting charge, or (b) imposing a known charge on the sensor and measuring the resulting voltage. Other methods, such as measuring the complex impedance of the sensor, may be used as well. Controller 110 takes information from the touch screen sensor and translates it for further digital signal processing (DSP) 120 to present it in a usable form for host processor 130. Changes in capacitance are translated into electronic signals that are converted to digital representations for processing in DSP 120, where signals from the sensors are converted into finger coordinates, gesture recognition, and so on. Additionally, DSP 120 is preferably configured to perform signal conditioning, smoothing and filtering, and contains the algorithmic processes for determining finger location, pressure, tracking and gesture interpretation.

Turning now to FIG. 3, an exemplary illustration of a touch sensor 300 is provided. Sensor 300 comprises drive lines 302 and sense lines 301 arranged in a perpendicular fashion, where voltage from signal source 310 provides capacitive nodes 303 at the intersection of each sense line 301. It should be noted that the term “lines” as used herein refers to conductive pathways, as one skilled in the art will readily understand, and is not limited to structures that are strictly linear, but includes pathways that change direction, and includes pathways of different size, shape, materials, etc. Drive lines 302 may be driven by stimulation signals from signal source 210, and resulting sense signals generated in sense lines 301 can be transmitted. In this way, drive lines and sense lines can be part of the touch sensing circuitry that can interact to form capacitive sensing nodes, which can be thought of as touch picture elements (touch pixels), such as the one shown in 304. After touch controller (110) has determined whether a touch has been detected at each touch pixel in the touch screen, the pattern of touch pixels in the touch screen at which a touch occurred can be thought of as an “image” of touch (e.g. a pattern of fingers touching the touch screen). When touched 304, capacitance forms between the finger and the sensor grid and the touch location can be computed based on the measured electrical characteristics of the grid layer. The output to multiplexer 311 is an array of capacitance values for each X-Y intersection. Analog-to-digital (A/D) converter 312 converts the multiplexer outputs 311 for DSP 313, which in turn provides an output 314 for use in a computing device. Under a preferred embodiment, signal source 310, multiplexer 311 and A/D converter 312 are arranged in the controller, such as the one illustrated in FIG. 1 (110). Other examples of touch sensors and touch screens may be found in U.S. Pat. No. 7,479,949 titled “Touch Screen Device, Method, and Graphical User Interface for Determining Commands by Applying Heuristics” to Jobs et al., and U.S. Pat. No. 7,859,521 titled “Integrated Touch Screen” to Hotelling et al., each of which are incorporated by reference in their entirety herein.

As mentioned previously, the discussion above was directed to capacitive touch screens, but those skilled in the art would appreciate that other technologies are applicable as well. For example, resistive touch screens have a touch screen controller that connects to a touch overlay comprising a flexible top layer and a rigid bottom layer separated by insulating dots. The inside surface of each of the two layers is coated with a transparent metal oxide coating of ITO that creates a gradient across each layer when voltage is applied. When a finger presses the flexible top sheet, electrical contact is created between the resistive layers, producing a switch closing in the circuit. Voltage is alternated between the layers, and the resulting X-Y touch coordinates are passed to the touch screen controller. The touch screen controller data is then passed on to the computer operating system for processing.

Resistive touch screens may be arranged with 4-wire, 5-wire, and 8-wire resistive overlays. In the case of a 4-wire overlay, both the upper and lower layers in the touch screen are used to determine the X and Y coordinates. The overlay may be constructed with uniform resistive coatings of ITO on the inner sides of the layers and silver buss bars along the edges, where the combination sets up lines of equal potential in both X and Y. During operation, the controller applies a voltage to the back layer. When the screen is touched, the controller probes the voltage with the coversheet, which represents an X-axis left-right position. The controller then applies voltage to the cover sheet probes voltage from the back layer to calculate a Y-axis up-down position. In a 5-wire configuration, one wire goes to the coversheet (which serves as the voltage probe for X and Y), and four wires go to corners of the back glass layer. The controller first applies voltage to corners causing voltage to flow uniformly across the screen from the top to the bottom. When touched, the controller reads the Y voltage from the coversheet. The controller then applies voltage again to the corners and reads the X voltage from the cover sheet.

An infrared touch screen uses an array of X-Y infrared LED and photo detector pairs around the edges of the screen to detect a disruption in the pattern of LED beams A Surface Acoustic Wave (SAW) touch screen is based on two transducers (transmitting and receiving) placed for the both of X and Y axis on the touch panel, and a reflector is placed on the glass. The controller sends electrical signal to the transmitting transducer, where the transducer converts the signal into ultrasonic waves and emits to reflectors that are lined up along the edge of the panel. After reflectors refract waves to the receiving transducers, the receiving transducer converts the waves into an electrical signal and sends back to the controller. When a finger touches the screen, the waves are absorbed, causing a touch event to be detected at that point.

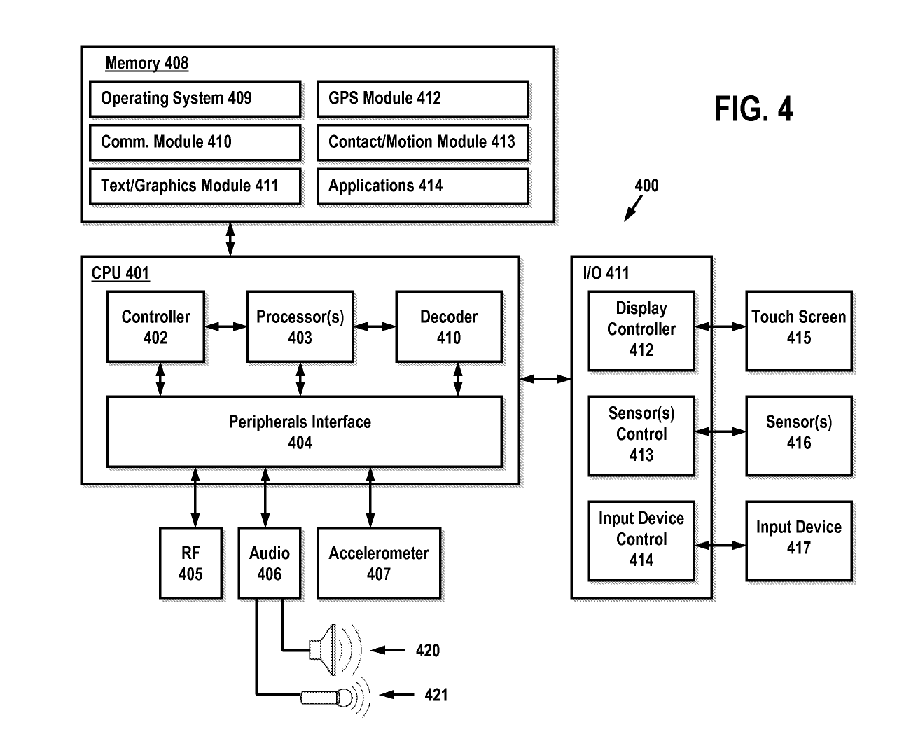

FIG. 4 is an exemplary embodiment of a touch-screen processing device 400, which may be a smart phone, tablet computer, or the like. Device 400 may include a central processing unit (CPU) 401 (which may include one or more computer readable storage mediums), a memory controller 402, one or more processors 403, a peripherals interface 404, RF circuitry 405, audio circuitry 406, a speaker 420, a microphone 420, and an input/output (I/O) subsystem 411 having display controller 412, control circuitry for one or more sensors 413 and input device control 414. These components may communicate over one or more communication buses or signal lines in device 400. It should be appreciated that device 400 is only one example of a portable multifunction device 400, and that device 400 may have more or fewer components than shown, may combine two or more components, or a may have a different configuration or arrangement of the components. The various components shown in FIG. 4 may be implemented in hardware, software or a combination of hardware and software, including one or more signal processing and/or application specific integrated circuits.

Decoder 410 serves to decode ancillary data embedded in audio signals in order to detect exposure to media. Examples of techniques for encoding and decoding such ancillary data are disclosed in U.S. Pat. No. 6,871,180, titled “Decoding of Information in Audio Signals,” issued Mar. 22, 2005, which is assigned to the assignee of the present application, and is incorporated by reference in its entirety herein. Other suitable techniques for encoding data in audio data are disclosed in U.S. Pat. Nos. 7,640,141 to Ronald S. Kolessar and 5,764,763 to James M. Jensen, et al., which are also assigned to the assignee of the present application, and which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

An audio signal which may be encoded with a plurality of code symbols is received at microphone 421, or via a direct link through audio circuitry 406. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 410 is capable of detecting codes in addition to those arranged in the formats disclosed hereinabove.

For received audio signals in the time domain, decoder 410 transforms such signals to the frequency domain preferably through a fast Fourier transform (FFT) although a direct cosine transform, a chirp transform or a Winograd transform algorithm (WFTA) may be employed in the alternative. Any other time-to-frequency-domain transformation function providing the necessary resolution may be employed in place of these. It will be appreciated that in certain implementations, transformation may also be carried out by filters, by an application specific integrated circuit, or any other suitable device or combination of devices. The decoding may also be implemented by one or more devices which also implement one or more of the remaining functions illustrated in FIG. 4.

The frequency domain-converted audio signals are processed in a symbol values derivation function to produce a stream of symbol values for each code symbol included in the received audio signal. The produced symbol values may represent, for example, signal energy, power, sound pressure level, amplitude, etc., measured instantaneously or over a period of time, on an absolute or relative scale, and may be expressed as a single value or as multiple values. Where the symbols are encoded as groups of single frequency components each having a predetermined frequency, the symbol values preferably represent either single frequency component values or one or more values based on single frequency component values.

The streams of symbol values are accumulated over time in an appropriate storage device (e.g., memory 408) on a symbol-by-symbol basis. This configuration is advantageous for use in decoding encoded symbols which repeat periodically, by periodically accumulating symbol values for the various possible symbols. For example, if a given symbol is expected to recur every X seconds, a stream of symbol values may be stored for a period of nX seconds (n>1), and added to the stored values of one or more symbol value streams of nX seconds duration, so that peak symbol values accumulate over time, improving the signal-to-noise ratio of the stored values. The accumulated symbol values are then examined to detect the presence of an encoded message wherein a detected message is output as a result. This function can be carried out by matching the stored accumulated values or a processed version of such values, against stored patterns, whether by correlation or by another pattern matching technique. However, this process is preferably carried out by examining peak accumulated symbol values and their relative timing, to reconstruct their encoded message. This process may be carried out after the first stream of symbol values has been stored and/or after each subsequent stream has been added thereto, so that the message is detected once the signal-to-noise ratios of the stored, accumulated streams of symbol values reveal a valid message pattern.

Alternately or in addition, processor(s) 403 can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., each of which is assigned to the assignee of the present application and both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO02/11123 to Wang, et al. and PCT publication WO91/11062 to Young, et al., all of which are incorporated herein by reference in their entireties. As discussed above, the code detection and/or signature extraction serve to identify and determine media exposure for the user of device 400.

Memory 408 may include high-speed random access memory (RAM) and may also include non-volatile memory, such as one or more magnetic disk storage devices, flash memory devices, or other non-volatile solid-state memory devices. Access to memory 408 by other components of the device 400, such as processor 403, decoder 410 and peripherals interface 404, may be controlled by the memory controller 402. Peripherals interface 404 couples the input and output peripherals of the device to the processor 403 and memory 408. The one or more processors 403 run or execute various software programs and/or sets of instructions stored in memory 408 to perform various functions for the device 400 and to process data. In some embodiments, the peripherals interface 404, processor(s) 403, decoder 410 and memory controller 402 may be implemented on a single chip, such as a chip 401. In some other embodiments, they may be implemented on separate chips.

The RF (radio frequency) circuitry 405 receives and sends RF signals, also called electromagnetic signals. The RF circuitry 405 converts electrical signals to/from electromagnetic signals and communicates with communications networks and other communications devices via the electromagnetic signals. The RF circuitry 405 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 405 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 406, speaker 420, and microphone 421 provide an audio interface between a user and the device 400. Audio circuitry 406 may receive audio data from the peripherals interface 404, converts the audio data to an electrical signal, and transmits the electrical signal to speaker 420. The speaker 420 converts the electrical signal to human-audible sound waves. Audio circuitry 406 also receives electrical signals converted by the microphone 421 from sound waves, which may include encoded audio, described above. The audio circuitry 406 converts the electrical signal to audio data and transmits the audio data to the peripherals interface 404 for processing. Audio data may be retrieved from and/or transmitted to memory 408 and/or the RF circuitry 405 by peripherals interface 404. In some embodiments, audio circuitry 406 also includes a headset jack for providing an interface between the audio circuitry 406 and removable audio input/output peripherals, such as output-only headphones or a headset with both output (e.g., a headphone for one or both ears) and input (e.g., a microphone).

I/O subsystem 411 couples input/output peripherals on the device 400, such as touch screen 415 and other input/control devices 417, to the peripherals interface 404. The I/O subsystem 411 may include a display controller 412 and one or more input controllers 414 for other input or control devices. The one or more input controllers 414 receive/send electrical signals from/to other input or control devices 417. The other input/control devices 417 may include physical buttons (e.g., push buttons, rocker buttons, etc.), dials, slider switches, joysticks, click wheels, and so forth. In some alternate embodiments, input controller(s) 414 may be coupled to any (or none) of the following: a keyboard, infrared port, USB port, and a pointer device such as a mouse, an up/down button for volume control of the speaker 420 and/or the microphone 421. Touch screen 415 may also be used to implement virtual or soft buttons and one or more soft keyboards.

Touch screen 415 provides an input interface and an output interface between the device and a user. The display controller 412 receives and/or sends electrical signals from/to the touch screen 415. Touch screen 415 displays visual output to the user. The visual output may include graphics, text, icons, video, and any combination thereof (collectively termed “graphics”). In some embodiments, some or all of the visual output may correspond to user-interface objects, further details of which are described below. As describe above, touch screen 415 has a touch-sensitive surface, sensor or set of sensors that accepts input from the user based on haptic and/or tactile contact. Touch screen 415 and display controller 412 (along with any associated modules and/or sets of instructions in memory 408) detect contact (and any movement or breaking of the contact) on the touch screen 415 and converts the detected contact into interaction with user-interface objects (e.g., one or more soft keys, icons, web pages or images) that are displayed on the touch screen. In an exemplary embodiment, a point of contact between a touch screen 415 and the user corresponds to a finger of the user. Touch screen 415 may use LCD (liquid crystal display) technology, or LPD (light emitting polymer display) technology, although other display technologies may be used in other embodiments. Touch screen 415 and display controller 412 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 412.

Device 400 may also include one or more sensors 416 such as optical sensors that comprise charge-coupled device (CCD) or complementary metal-oxide semiconductor (CMOS) phototransistors. The optical sensor may capture still images or video, where the sensor is operated in conjunction with touch screen display 415.

Device 400 may also include one or more accelerometers 407, which may be operatively coupled to peripherals interface 404. Alternately, the accelerometer 407 may be coupled to an input controller 414 in the I/O subsystem 411. In some embodiments, information displayed on the touch screen display may be altered (e.g., portrait view, landscape view) based on an analysis of data received from the one or more accelerometers.

In some embodiments, the software components stored in memory 408 may include an operating system 409, a communication module 410, a contact/motion module 413, a text/graphics module 411, a Global Positioning System (GPS) module 412, and applications 414. Operating system 409 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 410 facilitates communication with other devices over one or more external ports and also includes various software components for handling data received by the RF circuitry 405. An external port (e.g., Universal Serial Bus (USB), FIREWIRE, etc.) may be provided and adapted for coupling directly to other devices or indirectly over a network (e.g., the Internet, wireless LAN, etc.

Contact/motion module 413 may detect contact with the touch screen 415 (in conjunction with the display controller 412) and other touch sensitive devices (e.g., a touchpad or physical click wheel). The contact/motion module 413 includes various software components for performing various operations related to detection of contact, such as determining if contact has occurred, determining if there is movement of the contact and tracking the movement across the touch screen 415, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 413 and the display controller 412 also detects contact on a touchpad.

Text/graphics module 411 includes various known software components for rendering and displaying graphics on the touch screen 415, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 412 determines the location of the device and provides this information for use in various applications. Applications 414 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication.

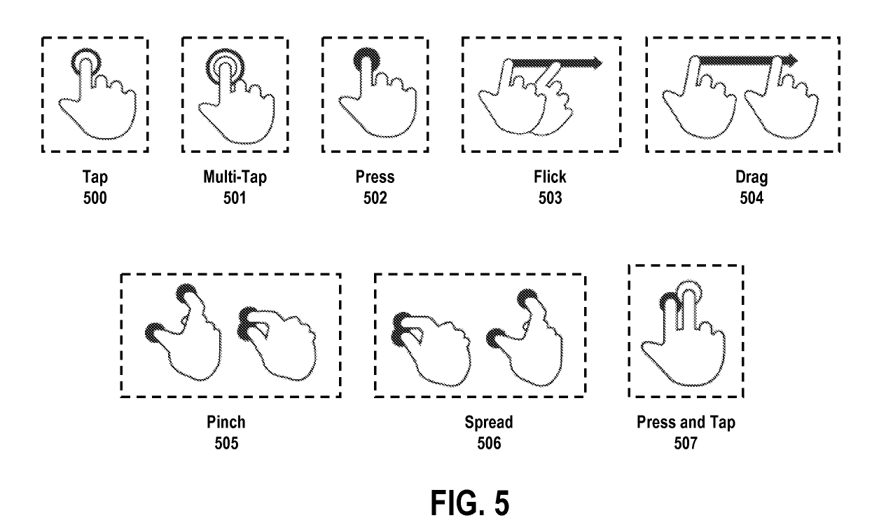

Turning to FIG. 5, an exemplary illustration is provided to show various types of touches, multi-touches and gestures detectable by device 400 and processed further to determine a touch profile. A tap 500 comprises of a brief touch on the touch screen surface with a fingertip, a multi-tap 501 comprises a rapid touch on the touch screen surface two or more times, a press 502 comprises a surface touch for an extended period of time, a flick 503 comprising a quick surface brush with a fingertip, and a drag 504 comprising a fingertip movement that does not lose contact from one point to another on the touch screen surface. Regarding multiple touches, a pinch 505 comprises touching the touch screen with two fingers and bringing them closer together, a spread 506 comprises touching the touch screen with two fingers and moving them apart, and a press and tap 507 comprises pressing the touch screen surface with one finger and briefly touching the surface with a second finger. The examples in FIG. 5 are provided for illustrative purposes only, and are not meant to be exhaustive. Other examples of gestures include multi-finger tap, multi-finger drag, two-finger drag, rotate, lasso-and-cross, splay, press and drag, and press-and-tap-then-drag.

As any or all of these touches and gestures are registered, each individual from a group of individuals (e.g., a member of a family) will display one or more touch/gesture characteristics (also referred to herein as a touch “profile”). For example, an adult male may tap and/or swipe a screen with greater force, resulting in a more pronounced signal. Conversely, children may tap and/or swipe a screen with less force, resulting in a weaker signal. Also, the manner in which an individual swipes, flicks, etc. will generate a unique electrical characteristic that may be used to identify a user. The speed in which a user taps a screen (e.g., when typing) may also be measured. In addition, finger size and orientation may be used to identify the user.

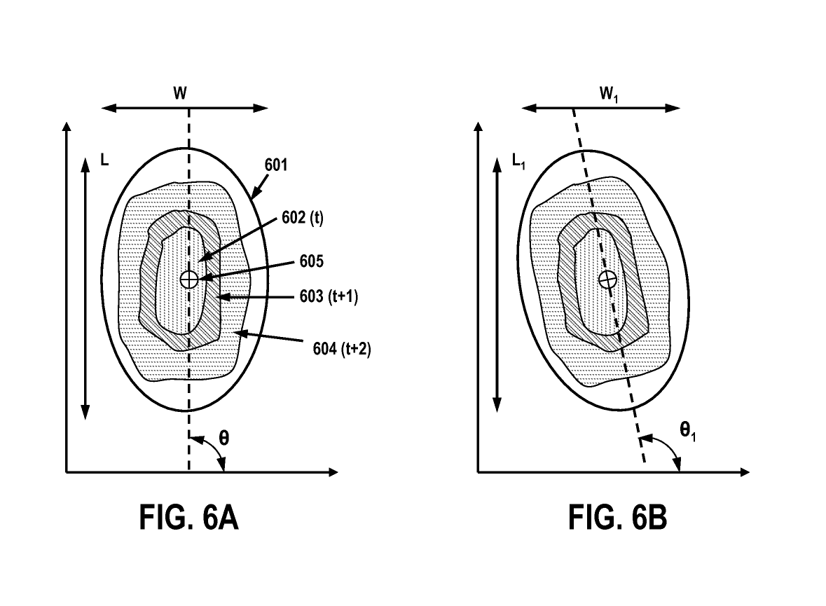

Turning to FIG. 6A, an exemplary diagram of a finger touch and orientation are provided. When a finger contacts a touch screen, contact is typically made with a vertical touch—when the finger is pointing directly downward towards the surface (e.g., 90° —and/or an oblique touch—when the finger contacts the surface at an oblique angle (e.g., 45°). During sensing, each frame of an input should contain all contact pixels on the surface. In the case of a tap or press, a connected component analysis may be performed to extract all finger contact regions. An algorithm may then be used to determine contact shape and orientation.

Sensors may be arranged to collect multiple data points from a single touch. In the example of FIG. 6A, a touch area 601 comprises a center coordinate 605 wherein a touch occurs. The initial area of contact 602 is measured at a first moment in time (t). As the finger depresses further onto the screen (t+1) a second, and larger area of contact is measured 603. As the finger becomes fully depressed onto the screen (t+2) a third area of contact 604 is measured. After a full depression the area of the touch 601 can be measured to determine touch size. Due to the configuration of fingers on the human hand, the center point of finger contact typically moves inward, toward a user's palm—the finger tip will contact the surface first; as the pad area of the finger increases its contact area, the center of the contact region shifts inward. By tracking the variation of the contact center during contact, it can be estimated which side the user's palm lies in and the consequent finger direction. It is understood by those skilled in the art that the three-area example is provided for the purposes of illustration only, and that greater or fewer areas of measurement may be used.

The fully depressed touch area may be determined by calculating the total number of pixels within the area. This area be represented as an elliptical shape, due to the soft and deformable tissues in the human finger, using least square fitting

$${( \frac{( x - {x}_{0} ) cos θ + ( y - {y}_{0} ) sin θ}{L / 2} )}^{2} + {( \frac{( y - {y}_{0} ) cos θ - ( x - {x}_{0} ) sin θ}{W / 2} )}^{2} = 1$$

where x₀ and y₀ are the center coordinates (605) relative to touch coordinates (x, y), where θ is the slant angle comprising the unidirectional orientation of the finger, and L and W define the length and width of the touch area, respectively. In the example of FIG. 6A, a substantially vertical touch (±10°) is illustrated. In FIG. 6B a finger touch is illustrated having a slanted orientation is shown, where slant angle θ₁ may be determined from the center coordinate relative to a touch area having a slightly different length (L₁) and width (W₁) as a result of the slant.

The touch orientation may thus be determined by utilizing the area and aspect ratio of the finger contact region, where an area exceeding a first threshold would be indicative of an oblique touch. Generally, the mean contact area in a vertical touch is between 28-34 mm², and the mean contact area for oblique touch is between 165-293 mm². To minimize the chances of a false reading for a “hard” vertical touch, the aspect ratio (length over width) of the touch area is determined to confirm that the shape elongation is in a proper direction, where aspect ratios exceeding a second threshold would further confirm an oblique touch.

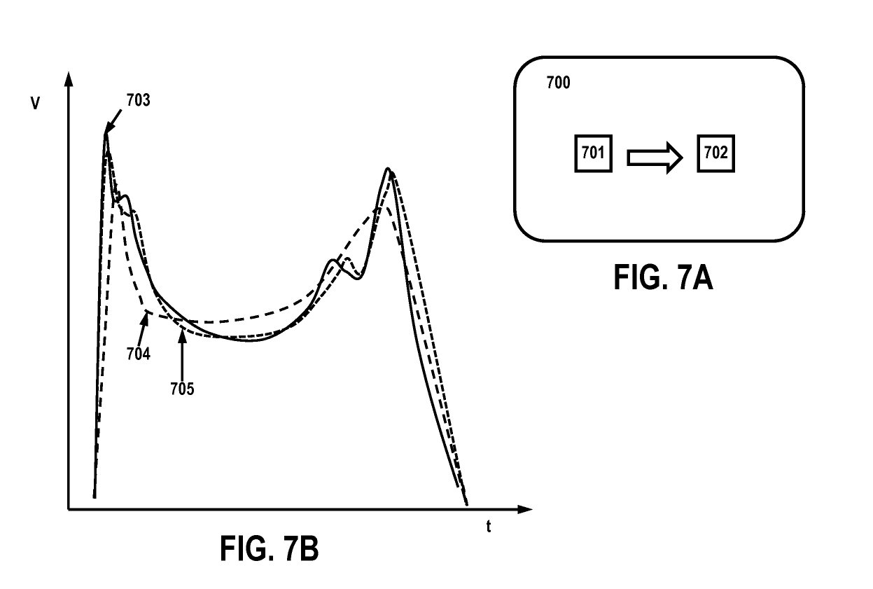

Turning to FIGS. 7A and 7B, a gestural characteristic is measured for a user. FIG. 7A illustrates an exemplary touch screen 700 executing a training module where an object in location 701 is flicked or dragged to location 702. As can be seen in FIG. 7B, the graph of sensor measurements shows three iterations (703, 704, 705) where a user initially depresses the screen object with greater force (701). The force then drops during the dragging (or flicking) process, and then increases again as the screen object is dragged and “dropped” to end location 702. It is understood that the graph of FIG. 7B is merely illustrative, and that any myriad of results can be measured, depending on the user's physical interaction with touch screen 700.

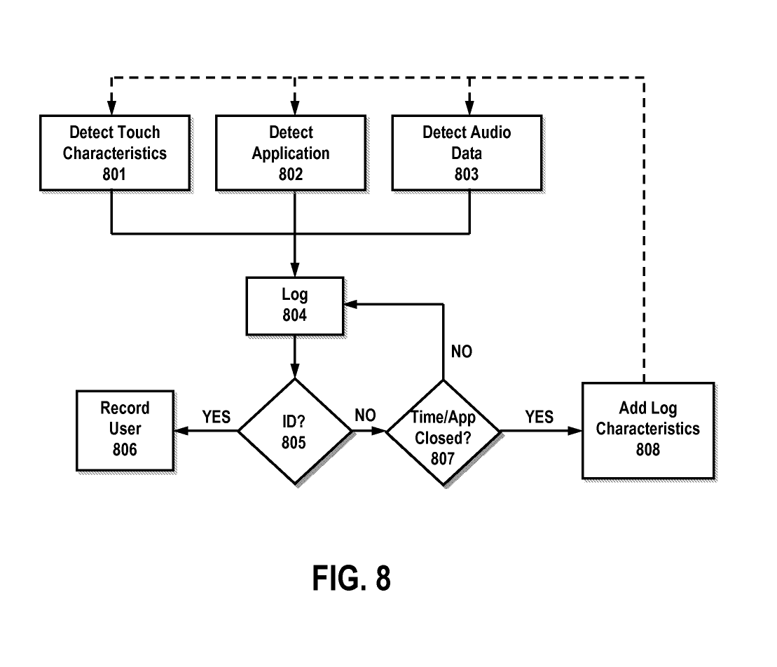

Turning now to FIG. 8, an exemplary process is disclosed for utilizing touch/gesture recognition together with media exposure data. During operation of touch screen device, touch characteristics are detected 801 using any of the techniques described above. Under a preferred embodiment, a training screen may be provided that instructs the user to engage in touch and/or gesture interaction with the device to detect characteristics of a tap, multi-tap, press, flick, drag, pinch, spread, press and tap, multi-finger tap, multi-finger drag, two-finger drag, rotate, lasso-and-cross, splay, press and drag, press-and-tap-then-drag, and the like. The electrical characteristics of each touch and/or gesture is stored as part of a user touch profile that may be used for identification.

Application detection module 802 registers applications being opened/accessed on the device at any given time. Furthermore, for applications generating metadata, such as a browser application, the metadata is collected on the device to determine such information as URL addresses, applets, plug-ins, and the like. Audio module 803 collects ancillary code (via decoder 410) and/or signatures collected from any of (a) ambient audio captured by a device microphone (421) from an external audio source, (b) ambient audio captured by a device microphone (421) from audio reproduced on the device (e.g. via speaker 420), and/or (c) audio captured directly from audio circuitry (406).

As touches/gestures are detected in module 801, they are correlated with application module 802 and audio data module 803 on a time base, and logged in module 804. Accordingly, when an application is accessed, the touches/gestures are recorded and correlated to the application during that time. Moreover, if a user is exposed to media containing an audio component, touches/gestures are also recorded and correlated to the time(s) in which audio media is detected. Of course, if audio media is detected at the same time an application is being accessed, the touches/gestures will be correlated to both the application and media data. As an example, a user may open and use a browser application on a device while listening to a radio or television broadcast. As the user browses the Internet via an application, the user's touches/gestures are recorded and correlated with the browsing session. At the same time, the ancillary codes and/or signatures detected from the radio/television broadcast are correlated to the touches/gestures detected for the browsing session occurring at that time. If the user continues listening to the broadcast, terminates the browsing session, and opens a new application, subsequent touches/gestures will be correlated to the new application and the broadcast.

In 805, the recorded touches/gestures are compared to a profile to determine if the touches/gestures are attributable to a specific person to provide identification. The comparisons may be done according to one or more statistical models (such as analysis of variance (ANOVA)) and/or heuristic models. If the touch/gesture characteristics match within a predetermined margin of error (e.g., 25%) it can be inferred that a given user is operating the touch screen device. The user match, along with any correlated applications and/or media exposure data, is then stored 806. If a sufficient level of matching is not detected, it is determined whether or not a particular application is closed, and/or a predetermined amount of time has passed in module 807. If the application is still in use, and/or the predetermined amount of time has not passed, the device continues to log further touches/gestures in 804. If the application is closed, and/or a predetermined amount of time has passed, the touch/gesture characteristics, along with any correlated applications and/or media exposure data, are added to a log 808 and registered under an anonymous user name that may be assigned automatically by the device. The process then continues back to the touch/gesture detection module 801, application detection module 802 and audio data detection module 803 for further processing.

Each user of a device should preferably have one or more touch/gesture profiles stored on a device, or alternately on a remote storage. In some cases, touches/gestures in 805 will not initially match, and may be assigned to an anonymous user name. However, if subsequent comparisons in 805 match the anonymous user name touch profile, the device may be configured to prompt the user with an identification question, such as “Are you [name]? The entries do not match your stored touch profile.” If the user answers in the affirmative, the touch/gesture data pertaining to the anonymous user is moved and renamed to appear as part of the registered user's touch/gesture profile. If the user answers “no” to the identification message, the device may prompt the user to add their name to the list of registered users for that device. Once registered, the touch/gesture data pertaining to the anonymous user is moved and renamed to appear as part of the new registered user's touch/gesture profile.

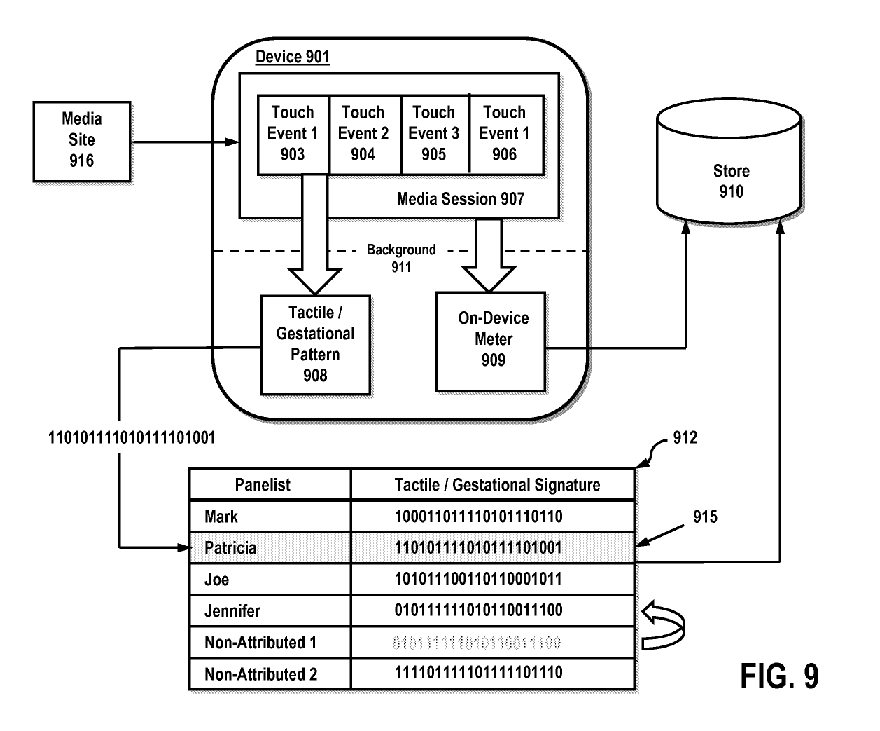

FIG. 9 discloses another embodiment where touch screen device 901 is equipped with on-device metering software 909 and tactile/gestational pattern generation software 908. Under a preferred embodiment, software 911 is installed/downloaded to device 901 and operates in the background 911. Here, device 901 receives media, such as one or more web pages, from media site 915 As media is received from media site 915, the media is recoded during media session 907, which communicates with on-device meter 909. During media session 907, touch events (e.g., tap, multi-tap, tap-and-drag) are recorded using any of the techniques described above. In the example of FIG. 9, touch events 903-905 are communicated to tactile/gestational pattern generation software 906, which forms touch “signatures”, and stores the events in storage 910. Storage 910 may be internal to device 901, or may be a remote storage (e.g., server) that receives the touch signature data via a computer or telephonic network.

For this example, storage 910 is configured to be remote from device 901, and receives a multitude of signatures from different devices associated with different users, or panelists (912). Here, four different panelists are registered (“Mark”, “Patricia”, “Joe”, and “Jennifer”), along with at least one associated tactile/gestational signature for each panelist. As each new touch or gesture signature is received, it is initially stored in an unattributed form (“non-attributed 1”, “non-attributed 2”), and then compared to each stored profile to determine if a certain level of similarity exists. The figure illustrates that an incoming touch signature (“110101111010111101001”) is initially stored as a non-attributed input (“non-attributed 1,” “non-attributed 2”). After comparing the stored profiles, it is discovered that a match (“non-attributed 1”) is a match for the profile for panelist “Patricia.” As such, the match is registered in storage 910. At substantially the same time (±5 sec.), media exposure data generated by on-device meter 909 relative to media site 916 is stored and associated with the matched signature via a processor (not shown), that may be communicatively coupled to storage 910. Accordingly, the configurations described above provide a powerful tool for confirming identification of users of touch screens for audience measurement purposes.

It will be understood that the term module as used herein does not limit the functionality to particular physical modules, but may include any number of software components. In general, a computer program product in accordance with one embodiment comprises a computer usable medium (e.g., standard RAM, an optical disc, a USB drive, or the like) having computer-readable program code embodied therein, wherein the computer-readable program code is adapted to be executed by processor 102 (working in connection with an operating system) to implement a method as described above. In this regard, the program code may be implemented in any desired language, and may be implemented as machine code, assembly code, byte code, interpretable source code or the like (e.g., via C, C++, C#, Java, Actionscript, Objective-C, Javascript, CSS, XML, etc.).

While at least one example embodiment has been presented in the foregoing detailed description, it should be appreciated that a vast number of variations exist. For instance, while the disclosure was focused primarily on touch screens, the same principles described herein are also applicable to touch pads (e.g., mouse pad embedded in a laptop), and any other technology that is capable of recognizing tactile or gestational inputs. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A computer-implemented method for confirming the identity of one or more users of a touch screen device, comprising the steps of:
receiving contact data from touch screen circuitry relating to a contact made with the touch screen device by a user;
receiving at least one of application data relating to one or more applications accessed in the touch screen device, and media exposure data relating to audio received in the touch screen device;
correlating the contact data with the at least one of application data and media exposure data; and
comparing the contact data with stored contact data to determine if a match exists.

2. The computer-implemented method of claim 1, wherein the touch screen is one of a capacitive touch screen, a resistive touch screen, an infrared touch screen and a surface acoustic wave touch screen.

3. The computer-implemented method of claim 1, wherein the contact data comprises electrical characteristics of one or more instances of contact of a user's finger with the touch screen.

4. The computer-implemented method of claim 3, wherein the one or more instances of contact comprise a continuous movement from one touch screen coordinate to a second touch screen coordinate.

5. The computer-implemented method of claim 3, wherein the electrical characteristics comprise one or more voltages associated with a force applied to the touch screen at the one or more instances of contact.

6. The computer-implemented method of claim 3, wherein the electrical characteristics comprise a finger orientation during the one or more instances of contact with the touch screen.

7. The computer-implemented method of claim 1, wherein the application data comprises metadata.

8. The computer-implemented method of claim 1, wherein the media exposure data comprises one of (a) ancillary codes detected from the audio, and (b) signatures extracted from the audio received in the touch screen device.

9. The computer-implemented method of claim 1, further comprising a step of generating a report based at least in part on correlating the contact data and comparing the contact data.

10. The computer-implemented method of claim 1, further comprising a step of identifying a user of the touch screen device, wherein the identification is based on a match from comparing the contact data with the stored contact data.

11. An apparatus for monitoring media consumption and identity of one or more users of a touch screen device, comprising:
a touch screen comprising touch screen circuitry configured to output contact data when contact is made on the touch screen by a user;
a media input configured to receive media data;
a storage device operatively coupled to the media input and touch screen circuitry and configured to store a contact profile comprising at least some of the contact data and media data;
a processor operatively coupled to the touch screen circuitry, media input and storage device, wherein the processor is configured to
process media data to produce media exposure data, and
process contact data and correlate it to the media exposure data;
wherein the processor is further configured to compare the processed contact data to the contact profile to determine if a match exists.

12. The apparatus of claim 11, wherein the touch screen is one of a capacitive touch screen, a resistive touch screen, an infrared touch screen and a surface acoustic wave touch screen.

13. The apparatus of claim 11, wherein the contact profile comprises electrical characteristics of one or more instances of contact of a user's finger with the touch screen.

14. The apparatus of claim 13, wherein the one or more instances of contact comprise a continuous movement from one touch screen coordinate to a second touch screen coordinate.

15. The apparatus of claim 13, wherein the electrical characteristics comprise one or more voltages associated with a force applied to the touch screen at the one or more instances of contact.

16. The apparatus of claim 13, wherein the electrical characteristics comprise a finger orientation during the one or more instances of contact with the touch screen.

17. The apparatus of claim 11, wherein the media data comprises metadata.

18. The apparatus of claim 11, wherein the media data comprises one of (a) ancillary codes detected from the audio, and (b) signatures extracted from the audio received in the touch screen device.

19. The apparatus of claim 11, wherein the processor is configured to generate a report based at least in part on the correlated contact data and media exposure data.

20. The apparatus of claim 11, wherein the processor is further configured to produce identification is based on a match from comparing the processed contact data to the contact profile.
